(19) United States
(12) Patent Application Publication
(10) Pub. No.: US 2025/0244582 A1
(43) Pub. Date: Jul. 31, 2025

(54) PASSIVE WORLD-REFERENCED SMARTGLASSES DISPLAY ALIGNMENT

(71) Applicant: GOOGLE LLC, Mountain View, CA (US)

(72) Inventors: Daniel Adema, Kitchener (CA); Timothy Paul Bodiya, Waterloo (CA)

(21) Appl. No.: 18/853,332

(22) PCT Filed: Apr. 5, 2023
(86) PCT No.: PCT/US2023/017537

§ 371 Date: Oct. 1, 2024

Related U.S. Application Data
(60) Provisional application No. 63/362,644, filed on Apr. 7, 2022.

(51) Int. Cl. G02B 27/01

(52) U.S. Cl. CPC G02B 27/0172; G02B 27/0176; G02B 2027/0138; G02B 2027/0178; G02B 2027/0198

(57) ABSTRACT

Improved techniques of aligning real and virtual images in an augmented reality head-mounted wearable device include rigidly coupling a world-facing radiation detector for processing real images to a projection system in a frame of the head-mounted wearable device for processing virtual images. In some implementations, the augmented reality head-mounted wearable device includes an input light direction rerouter configured to adjust an initial angle of incidence of the internally generated radiation at a surface of the waveguide to produce radiation directed at an adjusted angle of incidence at the incoupler such that the output direction is substantially parallel to the initial angle of incidence. In some implementations, the input light direction rerouter takes the form of a retroreflector that alters the input of the incident light from the projection system such that its direction is substantially a reciprocal of the output light vector.

### TECHNICAL FIELD

This description relates in general to head mounted wearable devices, and in particular, to head mounted wearable computing devices including a display device.

### BACKGROUND

Eyewear in the form of glasses may be worn by a user to, for example, provide for vision correction, inhibit sun/glare, provide a measure of safety, and the like. These types of eyewear are typically somewhat flexible and/or deformable, so that the eyewear can be manipulated to comfortably fit the user and allow the eyewear to flex during use and wear by the user. An ophthalmic technician can typically manipulate rim portions and/or temple arm portions of a frame of the eyewear, for example, through cold working the frame and/or heating and re-working the frame, to adjust the eyewear for a particular user. In some situations, this re-working of the frame may occur over time, through continued use/wearing of the eyewear by the user. Manipulation in this manner, due to the flexible and/or deformable nature of the material of the frame and/or lenses of the eyewear, may provide a comfortable fit while still maintaining ophthalmic alignment between the eyewear and the user. In a situation in which the eyewear is a head mounted computing device including a display, such as, for example, smartglasses, this type of flexibility/deformation in the frame may cause inconsistent alignment or the display, or mis-alignment of the display. Inconsistent alignment, or mis-alignment of the display can cause visual discomfort, particularly in the case of a binocular display. A frame having rigid/non-flexible components, while still providing some level of flexibility in certain portions of the frame, may maintain alignment of the display, and may be effective in housing electronic components of such a head mounted computing device including a display.

### SUMMARY

In one general aspect, a head-mounted wearable device includes a frame configured to be worn by a user. The frame includes a projection system configured to emit internally generated radiation. The frame also includes a world-facing radiation detector configured to detect externally generated radiation, the world-facing radiation detector being rigidly coupled to the projection system. The frame further includes a waveguide, including an incoupler configured to couple the internally generated radiation into the waveguide to produce radiation in the waveguide, and an outcoupler configured to couple the radiation in the waveguide out of the waveguide to produce outcoupled radiation, the outcoupled radiation being emitted from the outcoupler in an output direction toward an eye of the user. The frame further includes an input light direction rerouter configured to adjust an initial angle of incidence of the internally generated radiation at a surface of the waveguide to produce radiation directed at an adjusted angle of incidence at the incoupler such that the output direction is substantially parallel to the initial direction of incidence (parallel to the input direction, i.e., the direction of the internally generated radiation). For example, the incoupler, the waveguide and the outcoupler are configured and located in such a way that light arriving at the incoupler under an input angle relative to the incoupler (or a waveguide surface) is coupled out of the waveguide by the outcoupler under an output angle (relative to the outcoupler or the waveguide surface) which is at least essentially identical to the input angle such that the output direction is parallel (and opposite) to the initial input direction.

In another general aspect, a head-mounted wearable device includes a frame configured to be worn by a user. The frame includes a projection system configured to emit internally generated radiation. The frame also includes a world-facing radiation detector configured to detect externally generated radiation, the world-facing radiation detector being rigidly coupled to the projection system such that a direction of a chief ray of the world-facing radiation detector is at an angle substantially parallel to a direction of a chief ray of the projection system. The “chief ray” of the detector may refer to a main detection direction of the detector, e.g., a direction perpendicular to a detecting surface of the detector. The frame further includes a waveguide, including an incoupler configured to couple the internally generated radiation into the waveguide to produce radiation in the waveguide, and an outcoupler configured to couple the radiation in the waveguide out of the waveguide to produce outcoupled radiation, the outcoupled radiation being emitted from the outcoupler in an output direction toward an eye of the user.

In another general aspect, a head-mounted wearable device includes a frame configured to be worn by a user. The frame includes a nose bridge. The nose bridge includes a projection system configured to emit internally generated radiation. The nose bridge also includes a world-facing radiation detector configured to detect externally generated radiation, the world-facing radiation detector being rigidly coupled to the projection system. The nose bridge further includes a rigid frame enclosing the projection system and the world-facing radiation detector. The frame also includes a waveguide, including an incoupler configured to couple the internally generated radiation into the waveguide to produce radiation in the waveguide, and an outcoupler configured to couple the radiation in the waveguide out of the waveguide to produce outcoupled radiation, the outcoupled radiation being emitted from the outcoupler in an output direction toward an eye of the user.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example system, in accordance with implementations described herein.

FIG. 1B is a front view, FIG. 1C is a rear view, and FIG. 1D is a perspective view, of the example head mounted wearable device shown in FIG. 1A, in accordance with implementations described herein.

FIGS. 2A and 2B are diagrams that illustrate top views illustrating an example effect of flexing a frame of smartglasses on input and output ray directions.

FIGS. 3A and 3B are diagrams that illustrate top views illustrating an example effect of flexing a frame of smartglasses on camera alignment.

FIG. 4 is a diagram that illustrates an example reciprocal relationship between input and output vectors.

FIGS. 5A and 5B are diagrams that illustrate an example improved system using a retroreflector, in accordance with implementations described herein.

FIGS. 6A, 6B, and 6C are diagrams that illustrate an example improved system using a retroreflector disposed on an opposite waveguide surface from the incoupler, in accordance with implementations described herein.

FIGS. 7A and 7B are diagrams that illustrate an example improved system using a retroreflector disposed on an opposite waveguide surface from the incoupler through which the incident light passes, in accordance with implementations described herein.

FIG. 8 is a diagram that illustrates an example improved system with no retroreflector but with the camera at a reciprocal angle from the chief ray of the projection system, in accordance with implementations described herein.

FIGS. 9A and 9B are diagrams that illustrate a nose bridge binocular display, in accordance with implementations described herein.

FIG. 10 is a diagram that illustrates a split pupil bi-ocular display with reflective incoupler facets.

FIG. 11 is a diagram illustrating a system with multiple incouplers.

### DETAILED DESCRIPTION

This disclosure relates to mechanisms for eyewear in augmented or mixed reality (AR/MR) that ensure alignment of real and virtual objects on left and right displays of the eyewear regardless of the bending of the eyewear frame. For example, ophthalmic glasses frames should have some compliance or flexibility for the comfort of the wearer. Such glasses are typically somewhat flexible and/or deformable so that the glasses can be manipulated to adapt to a particular head size and/or shape, a particular arrangement of features, a preferred pose of the glasses on the face, and the like, associated with a user to provide a comfortable fit for the user. Along these lines, a frame of the eyewear can be deformed by, for example, heating and re-forming plastic frames, or bending/flexing frames made of other materials. Thus, flexible or deformable characteristics of the material of the frame of the eyewear may allow the eyewear to be customized to fit a particular user, while still maintaining the functionality of the eyewear.

A technical problem with allowing such flexibility in the frame is that such flexibility may cause misalignment of real and virtual objects in the displays of the eyewear. For example, alignment of real and virtual images in the displays may depend on a fixed relationship between directions of a light propagation vectors at a respective ingress and egress of the waveguide, i.e., input and output light propagation vectors. Specifically, for certain optical systems the input and output light propagation vectors have reciprocal direction vectors, i.e., have equal angles with respect to respective waveguide surface normals in opposite directions. Nevertheless, in a situation in which the eyewear is in the form of smartglasses including display capability, computing/processing capability, and the like, a flexible or deformable frame may cause a movement of a waveguide relative to the projector (input) and/or the user's eye (output) in the smartglasses frame. Such a movement of the waveguide may affect the direction of the output light propagation vector, which in turn may result in the location of virtual images on the display to be variable.

Keeping the frame of the eyewear rigid to avoid any flexibility that could cause the displays to move and misalign the real and virtual images in the displays. This, however, may add undesirable weight to the eyewear and cause the user to experience discomfort wearing the eyewear.

A control system for the cameras and other sensors mounted on the frame of the eyewear could be used to dynamically adjust the displays for variance of the positions of the displays. Such control systems, however, may add cost and complexity, as well as size and power usage. to the augmented reality system. The complexity, along with increasing the cost of the system, may also cause a processing lag because of the complexity of the controls needed to adjust the virtual images in real time.

Improved techniques of aligning real and virtual images in an augmented reality head-mounted wearable device include rigidly coupling a world-facing radiation detector for processing real images to a projection system in a frame of the head-mounted wearable device for processing virtual images. These improved techniques can be a technical solution to the technical problems described above. In some implementations, the augmented reality head-mounted wearable device includes an input light direction rerouter configured to adjust an initial angle of incidence of the internally generated radiation at a surface of the waveguide to produce radiation directed at an adjusted angle of incidence at the incoupler such that the output direction is substantially parallel to the initial angle of incidence. In some implementations, the input light direction rerouter takes the form of a retroreflector that alters the input of the incident light from the projection system such that its direction is substantially a reciprocal of the output light vector. An advantage of the improved techniques over the conventional approaches is that alignment of real and virtual images and binocular fusion are achieved without introducing additional complexity that could increase cost and affect performance.

It is noted that the world-facing radiation detector detects electromagnetic radiation. In some implementations, the radiation detected is light (e.g., optical wavelength band of the electromagnetic spectrum) In some implementations, the radiation detected is in the infrared wavelength band of the electromagnetic spectrum.

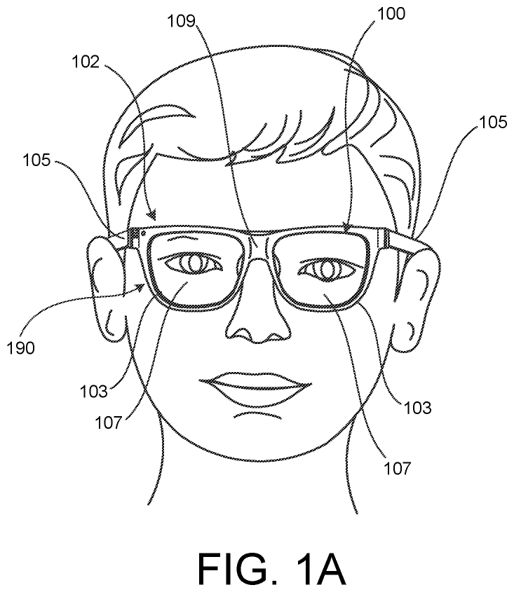

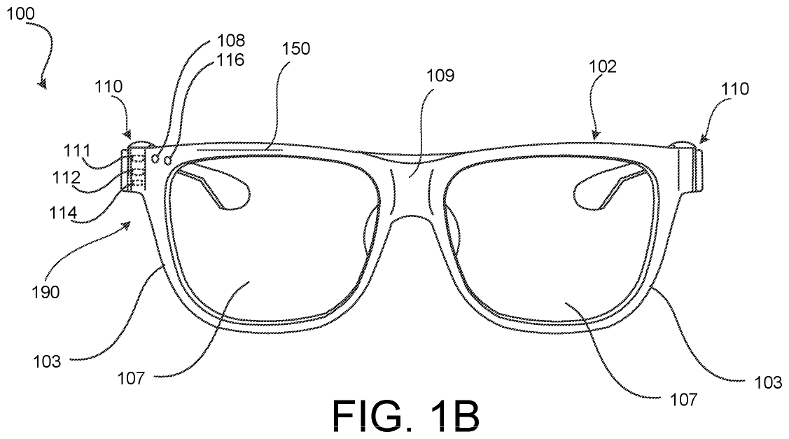

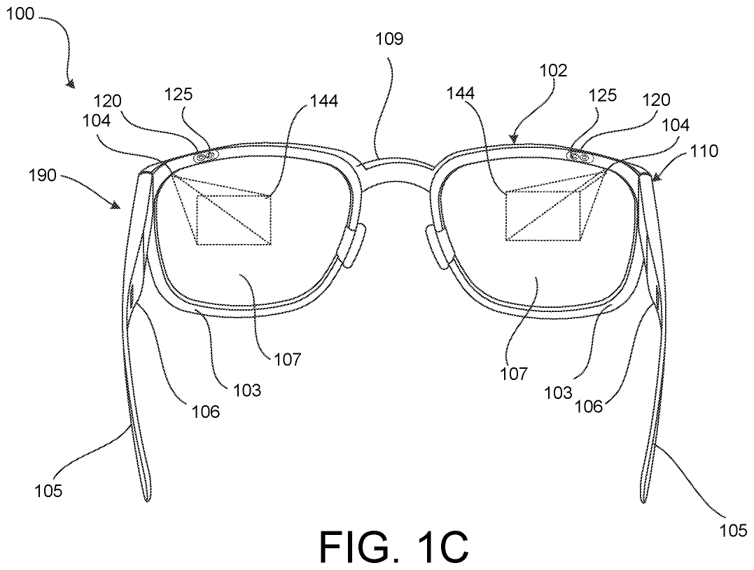

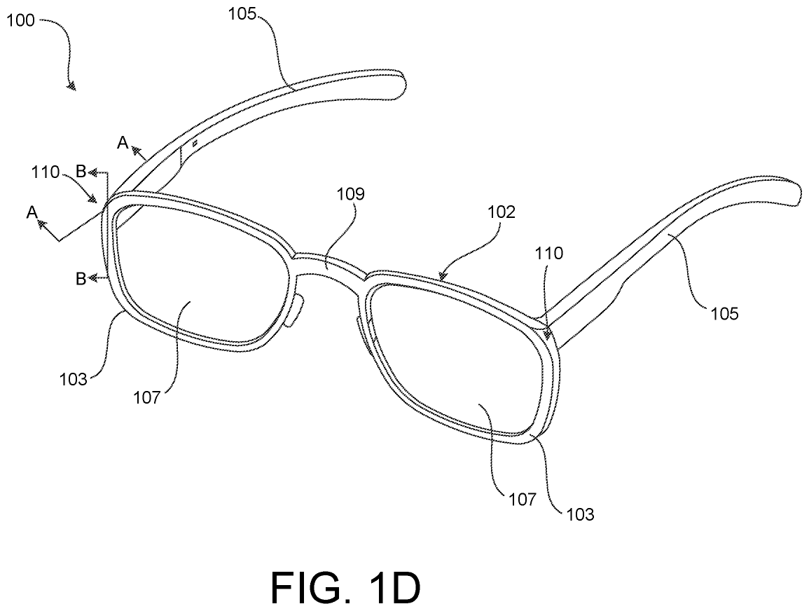

FIG. 1A illustrates a user wearing an example head mounted wearable device 100. In this example, the example head mounted wearable device 100 is in the form of example smartglasses including display capability and computing/processing capability, for purposes of discussion and illustration. The principles to be described herein may be applied to other types of eyewear, both with and without display capability and/or computing/processing capability. FIG. 1B is a front view, FIG. 1C is a rear view, and FIG. 1D is a perspective view, of the example head mounted wearable device 100 shown in FIG. 1A. As noted above, in some examples, the example head mounted wearable device 100 may take the form of a pair of smartglasses, or augmented reality glasses. The head mounted wearable device 100 shown in FIGS. 1A through 1D includes a nose bridge 109, rim portions 103, and respective arm portions 105. The junctions between the rim portions 103 and arm portions 105 form shoulders. The material in the nose bridge 109 has a first bending stiffness and the material in the shoulders has a second bending stiffness such that the first bending stiffness and the second bending stiffness satisfy a specified relationship.

As shown in FIG. 1B-1D, the example head mounted wearable device 100 includes a frame 102 worn by a user. The frame 102 includes a front frame portion defined by rim portions 103 surrounding respective optical portions in the form of lenses 107, with a bridge portion 109 connecting the rim portions 109. Arm portions 105 are coupled, for example, pivotably or rotatably coupled, to the front frame by hinge portions 110 at the respective rim portion 103. In some examples, the lenses 107 may be corrective/prescription lenses. In some examples, the lenses 107 may be an optical material including glass and/or plastic portions that do not necessarily incorporate corrective/prescription parameters. A display device 104 may be coupled in a portion of the frame 102. In the example shown in FIGS. 1B and 1C, the display device 104 is coupled in the arm portion 105 of the frame 102. With the display device 104 coupled in the arm portion 105, an eye box 140 extends toward the lens(es) 107, for output of content at an output coupler 144 at which content output by the display device 104 may be visible to the user. In some examples, the output coupler 144 may be substantially coincident with the lens(es) 107. In some examples, the head mounted wearable device 100 can also include an audio output device 106 (such as, for example, one or more speakers), an illumination device 108, a sensing system 111, a control system 112, at least one processor 114, and an outward facing image sensor 116, or world-facing camera 116.

In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 107 (e.g., real images), next to content (for example, digital images, user interface elements, virtual images, and the like) generated by the display device 104.

Waveguide optics 150 within the frame 102 are used to depict content on the display device 104. Such waveguide optics may be sensitive to the frame deformations resulting in real and virtual images that may become misaligned. Given the sensitivity of the waveguide optics 150 to frame deformations, a novel way to align real and virtual images in the display 104 is to reroute incident light from the projector onto an incoupler of the waveguide 150 such that the output light direction (e.g., light output by the waveguide outcoupler) is essentially parallel (e.g., to within 0.5 degrees or less) to the incident (input) light direction. Such a way involves the use of an input light direction retroreflector configured to adjust an initial angle of incidence of the internally generated radiation at a surface of the waveguide 150 to produce radiation directed at an adjusted angle of incidence at an incoupler such that the output direction is essentially parallel to the initial angle of incidence.

In some examples, the head mounted wearable device 100 may include a gaze tracking device 120 including, for example, one or more sensors 125, to detect and track eye gaze direction and movement. Data captured by the sensor(s) 125 may be processed to detect and track gaze direction and movement as a user input. In some examples, the sensing system 111 may include various sensing devices and the control system 112 may include various control system devices including, for example, one or more processors 114 operably coupled to the components of the control system 112. In some examples, the control system 112 may include a communication module providing for communication and exchange of information between the wearable computing device 100 and other external devices.

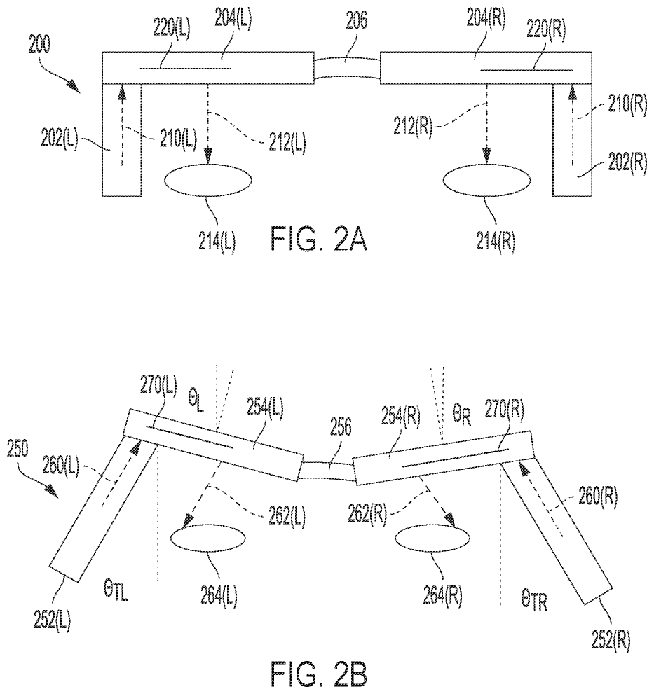

FIG. 2A is a top view illustrating an example unflexed frame 200 of smartglasses. As shown in FIG. 2A, the frame 200 includes left and right arm portions 202(L,R) housing a source of beams of input radiation 210(L,R), frame front portions 204(L,R) (i.e., rim portions) housing a waveguide 220(L,R) configured to combine real and virtual images and output the images in beams of output radiation 212(L,R), and nose bridge 206. In FIG. 2A, the beams of input radiation 210(L,R) propagate in a direction parallel to normal to the waveguide and, accordingly, the beams of output radiation 212(L,R) propagate in a direction substantially parallel to the respective beams of input radiation 210(L,R).

FIG. 2B is a top view illustrating an effect of an example flexed frame 250 of smartglasses on input and output ray directions. As shown in FIG. 2B, the frame 250 includes left and right arm portions 252(L,R) housing a source of beams of input radiation 260(L,R), frame front portions 254(L,R) (i.e., rim portions) housing a waveguide 270(L,R) configured to combine real and virtual images and output the images in beams of output radiation 262(L,R), and nose bridge 256. There is a flexing of the frame 250 through the nose bridge 256—defining deflection angles θ_{L} and θ_{R}—and at the junctions between rim portions 254(L,R) and respective arm portions 260(L,R)—defining deflection angles θ_{TL} and θ_{TR}. In general, θ_{L}≠θ_{R} and θ_{TL}≠θ_{TR}; in that case, without input light rerouting the beams of output radiation 262(L,R) are differently oriented at each eye. This may cause confusion for the user.

Such confusion for the user may be mitigated by aligning the real and virtual images in the display. This alignment may be performed, despite θ₁≠θ_{R} and θ_{TL}≠θ_{TR}, by using an input light direction rerouter (not shown) with the waveguide 270(L,R). Such a rerouter is configured to adjust an initial angle of incidence of the internally generated radiation at a surface of the waveguide to produce radiation directed at an adjusted angle of incidence at an incoupler such that the output direction is essentially parallel to the initial angle of incidence as shown in FIG. 2B.

It is noted that the internally generated radiation includes electromagnetic radiation. In some implementations, the electromagnetic radiation includes light (e.g., in the optical wavelength band of the electromagnetic spectrum). In some implementations, the electromagnetic radiation is in the infrared wavelength band of the electromagnetic spectrum.

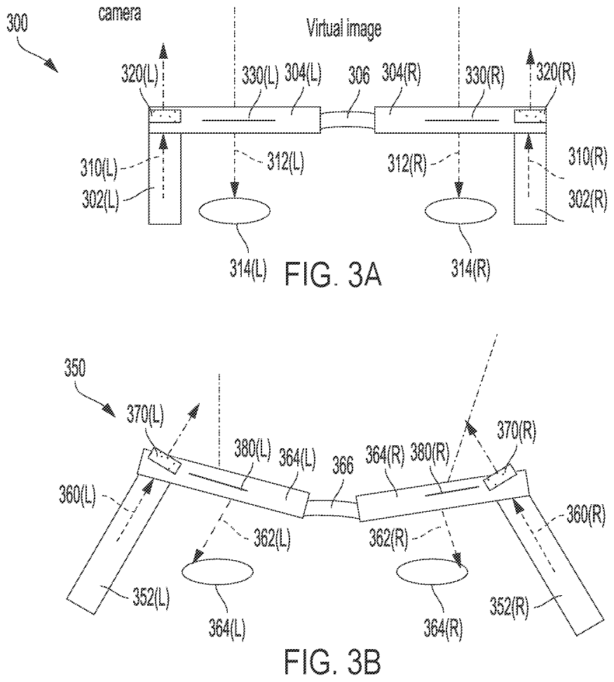

FIG. 3A is a top view illustrating an unflexed frame 300 of smartglasses. As shown in FIG. 3A, the frame 300 includes left and right arm portions 302(L,R) housing a source of beams of input radiation 310(L,R), frame front portions 304(L,R) (i.e., rim portions) housing a waveguide 330(L,R) configured to combine real and virtual images and output the images in beams of output radiation 312(L,R), and nose bridge 306. Attached to the rim portions 304(L,R) are respective external radiation detectors, i.e., world-facing cameras 320(L,R). In this state as shown in FIG. 3A, the display orientation may be calibrated to the orientation of the cameras 320(L,R). In this way, the virtual objects may be located relative to the real world objects captured by the cameras 320(L,R).

FIG. 3B is a top view illustrating an effect of an example flexed frame 350 of smartglasses on input and output ray directions. As shown in FIG. 3B, the frame 350 includes left and right arm portions 352(L,R) housing a source of beams of input radiation 360(L,R), frame front portions 354(L,R) (i.e., rim portions) housing a waveguide 380(L,R) configured to combine real and virtual images and output the images in beams of output radiation 362(L,R), and nose bridge 356. There is a flexing of the frame 350 through the nose bridge 356 and at the junctions between rim portions 354(L,R) and respective arm portions 360(L,R). Attached to the rim portions 354(L,R) are respective external radiation detectors, i.e., world-facing cameras 370(L,R). Without light direction rerouters, the relationship between the camera orientation and the display orientation is broken. This may lead to misalignment of real and virtual objects.

Such a misalignment of the real and virtual images may be mitigated by designing the waveguide such that the input light direction into the waveguide and output light direction from the waveguide are essentially parallel. This may be done using an input light direction rerouter (not shown) with the waveguide 380(L,R). Such a rerouter is configured to adjust an initial angle of incidence of the internally generated radiation at a surface of the waveguide to produce radiation directed at an adjusted angle of incidence at an incoupler such that the output direction is essentially parallel to the initial angle of incidence.

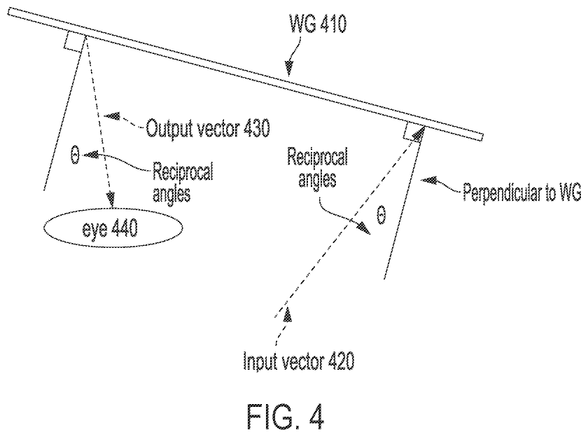

FIG. 4 illustrates an example reciprocal relationship between input and output radiation vectors (i.e., “input vector” and “output vector”). As shown in FIG. 4, the input vector (input light direction) 420 and output vector (output light direction) 430 are at reciprocal angles, meaning that they deviate from the respective surface normals to the waveguide WG 410 (analogous to waveguide 220(L) in FIG. 2A, 270(L) in FIG. 2B, etc.) at the respective ingress and egress points by the same angle θ. It is noted that, at these ingress and egress points, there is a respective incoupler and outcoupler (not shown) which usually take the form of a grating (e.g, diffractive, holographic, reflective) configured (e.g., pitch, blaze angle, surface profile) to efficiently produce radiation beams such that the output vector 430 is emitted to the eye 440 from the outcoupler at the angle θ reciprocal to the angle of incidence of the input vector 420 at the ingress point. It is noted that the reciprocal relationship between input vector 420 and output vector 430 holds as long as the overall dispersion of the diffraction gratings is insignificant.

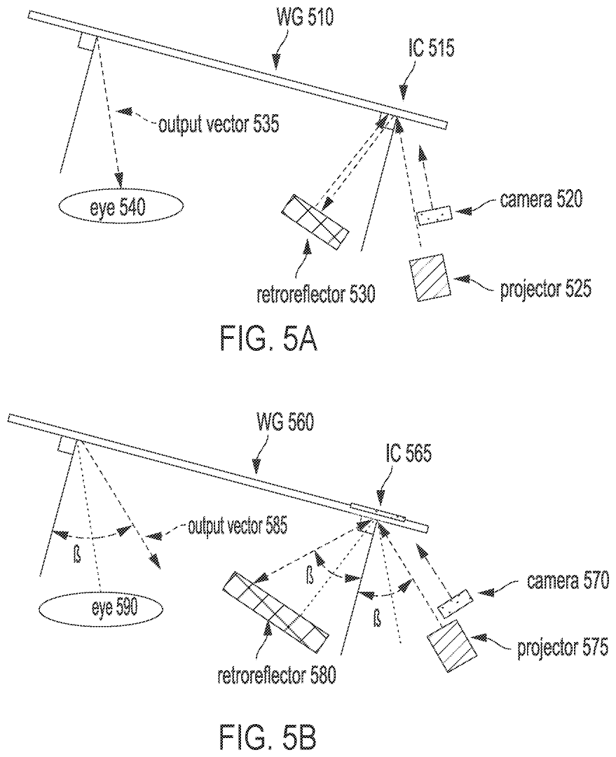

FIGS. 5A and 5B illustrate an example system using a retroreflector, in accordance with implementations described herein. As shown in FIG. 5A, the system includes a waveguide WG 510 with an incoupler IC 515 on a surface of the WG 510. As mentioned previously, the IC 515 may be a grating (e.g., diffractive, holographic, reflective). In some implementations, the IC 515 is a blazed diffraction grating. In some implementations, the IC 515 is a volume holographic grating.

The system as shown in FIG. 5A further includes a camera (e.g., world-facing radiation detector) 520 for capturing images of real objects (e.g., detecting externally generated radiation) and a projector 525 (i.e., projection system) for transmitting images of virtual objects to the WG 510. In this improved system, the camera and the projection system are designed such that the output light vector 535 (i.e., “output vector”) from the WG 510 is substantially parallel (e.g., to within 0.5 degrees) to the camera orientation. That is, the camera 520 will be pointed at the same location at which the virtual image is located.

More generally, the system as shown in FIG. 5A may be designed such that the camera 520 and the projection system 525 are rigidly coupled, e.g., the respective chief rays of the camera and the projection system have a fixed relationship. In some implementations, the chief rays are substantially parallel. In some implementations, the chief rays differ by a specified angle.

Also shown in FIG. 5A, the improved system includes an input light direction rerouter 530, which in the case illustrated, is a retroreflector disposed on a side of the WG 510 opposite the side to which the surface on which the IC 515 is disposed faces. The purpose of the light direction rerouter 530 is to change the direction of light input into the incoupler 515 such that the output vector 535 is substantially parallel to the input vector, independent of the flexing of the frame.

As show in in FIG. 5A, the retroreflector 530 is positioned so that the reflected beam is incident on the WG 510 at an angle reciprocal to the initial angle of incidence θ. Accordingly, the output vector 535 has a direction substantially parallel to the input vector. More particularly, the incoupler 515, the waveguide 510 and the outcoupler are configured and located in such a way that light arriving at the incoupler 515 under an input direction (angle) relative to the incoupler (or a waveguide surface) is coupled out of the waveguide by the outcoupler under an output angle (relative to the outcoupler or the waveguide surface) which is at least substantially identical to the input direction (e.g., the output direction is substantially parallel to the input direction).

In FIG. 5B, the system includes a waveguide WG 560 with an incoupler IC 565 on a surface of the WG 560. As mentioned previously, the IC 565 may be a grating (e.g., diffractive, holographic, reflective). In some implementations, the IC 565 is a blazed diffraction grating. In some implementations, the IC 565 is a volume holographic grating.

The system as shown in FIG. 5B further includes a camera 570 for capturing images of real objects and a projector 575 (i.e., projection system) for transmitting images of virtual objects to the WG 560. In this improved system, the camera and the projection system are designed such that the output light vector 585 (i.e., “output vector”) from the WG 560 is always substantially parallel to the camera orientation (e.g., input direction, input vector). That is, the camera 570 will be pointed at the same location at which the virtual image is located.

More generally, the system as shown in FIG. 5B may be designed such that the camera 570 and the projection system 575 are rigidly coupled, i.e., the respective chief rays of the camera and the projection system have a fixed relationship. In some implementations, the chief rays are essentially parallel. In some implementations, the chief rays differ by a specified angle.

Also shown in FIG. 5B, the system includes an input light direction rerouter 580, which in the case illustrated, is a retroreflector disposed on a side of the WG 560 opposite the side to which the surface on which the IC 565 is disposed faces.

FIG. 5B illustrates how this parallelism appears between input and output vectors 585 when the retroreflector 580 is off-axis at an angle β.

It is noted that the waveguide of the system, when there is insignificant dispersion (e.g., via canceling), the waveguide preserves input in plane k-vectors (i.e., directions of propagation in isotropic media). This is true no matter what orientation the waveguide has with respect to the projector. When the light is “transmitted” by the waveguide, input angles and output angles are essentially equal. Accordingly, there is more flexibility for the waveguide to move around.

It is noted that the condition of camera-projection system being rigidly coupled applies only to maintain the alignment relationship between the camera and the projector. There is no such rigid coupling or relationship between the projection system and the waveguide, for example. This is in significant contrast with conventional systems where the entire headset is required to be rigid. Such a relaxation of a rigidity requirement enables smaller, lighter, and more flexible smartglasses.

It is noted that the rigid coupling between the camera and projection system eliminates the need for real-time alignment monitoring feedback loops between the real objects and virtual objects. In some implementations, there may be an initial calibration to set the alignment between the projector and camera, but this calibration should only be done at initial setup and not during device use. Although the camera and projector are nominally oriented in the same direction, there may be other contributions that exist from display plane mismatch, ophthalmic lens, etc. that may need to be accounted for in aligning the real and virtual objects. It is further noted that variability in the angular position may have impacts on other display parameters such as brightness and uniformity.

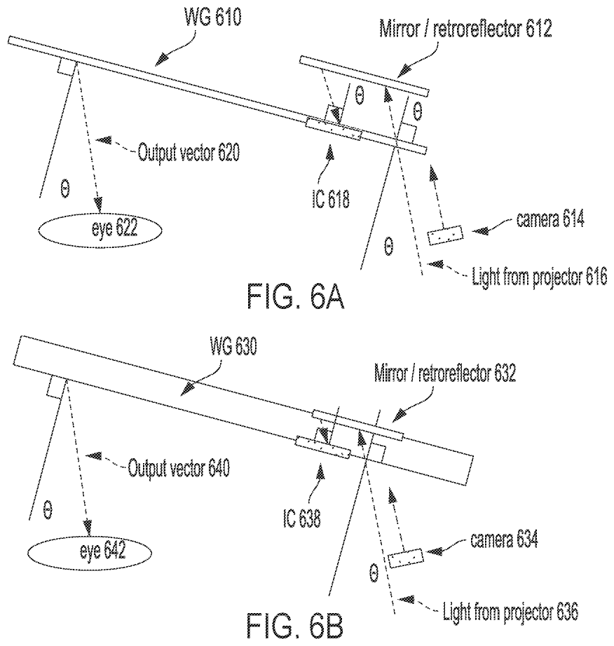

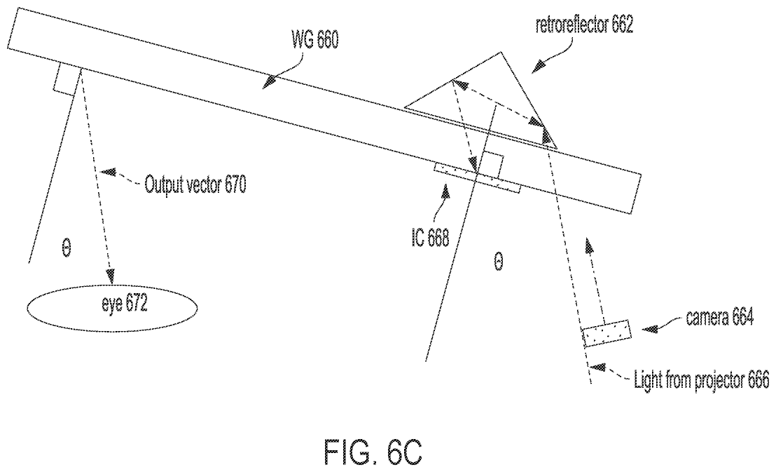

FIGS. 6A, 6B, and 6C illustrate an example system using a retroreflector disposed on an opposite waveguide surface from the incoupler IC, in accordance with implementations described herein. As shown in FIG. 6A, the input vector 616 from the projection system (not shown) passes through the waveguide 610 and reflects off a mirror/retroreflector 612 disposed essentially parallel to the waveguide WG 610. In some implementations as shown in FIG. 6A, the IC is a component separate from the WG 610.

As shown in FIG. 6B, the input vector 636 from the projection system (not shown) passes through the waveguide 630 and reflects off a mirror/retroreflector 632 disposed essentially parallel to the waveguide WG 630. In some implementations as shown in FIG. 6B, the IC 638 is the surface of the waveguide. It is noted that, in the system illustrated in FIG. 6B, there is a lateral shift in the retroreflector 632 so that the IC 638 is bypassed on the initial path (i.e., at incidence).

As shown in FIG. 6C, the input vector 666 from the projection system (not shown) passes through the waveguide 660 and reflects off a mirror/retroreflector 662 disposed parallel to the waveguide WG 660. FIG. 6C shows a scenario in which the radiation passes through the WG 660 first and is then retroreflected back to the IC 668. In this case, in some implementations the retroreflector 662 takes the form of a prism configured to output a beam at an angle of incidence on the IC 668 such that the output vector 670 is essentially parallel to the input vector (light from projector 666).

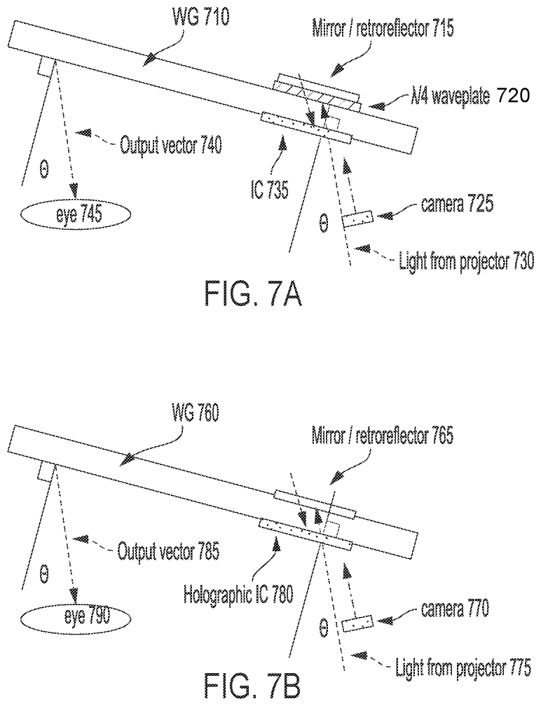

FIGS. 7A and 7B illustrate an example improved system using a retroreflector disposed on an opposite waveguide surface from the incoupler through which the incident light passes, in accordance with implementations described herein. In some implementations and as shown in FIGS. 7A and 7B, the incident light passes through the waveguide surface prior to reflecting from the retroreflector. In some implementations and as shown in FIGS. 7A and 7B, the retroreflector forms a part of a waveguide surface opposite to the opposite waveguide surface on which the incoupler is disposed.

FIG. 7A shows an implementation in which the input radiation (light from projector 730) passes through a quarter-wave plate 720 twice (transmitted and reflected directions) before incidence at the IC 735. In this case, the quarter-wave plate 720 changes the polarization of the input radiation 730 from a first state to a second state for which the IC 735 is configured to produce input into the WG 710 for output 740 essentially parallel to the input 730.

FIG. 7B shows the IC 780 as an angularly selective holographic grating such that the incident light 775 is transmitted through the IC 780 unchanged, but reflected light interacts with the grating.

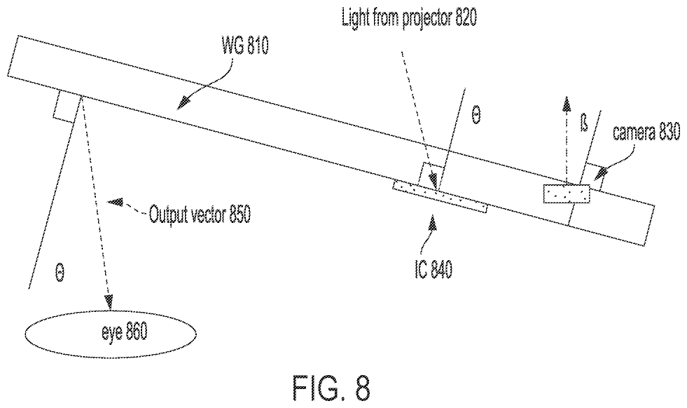

FIG. 8 illustrates an example improved system with no retroreflector but with the camera 830 at a reciprocal angle from the chief ray 820 of the projection system, in accordance with implementations described herein. In the scenario shown in FIG. 8, the camera 820 chief ray is set to a fixed, rigid angular offset from the chief ray 830 of the projection system. That is, the difference |θ−β| is fixed independent of flex in the smartglasses. For example, in some implementations, the camera 830 is set to be oriented at the reciprocal angle from the projection system chief ray 820. In such an implementation, the system may not need additional reflections for the input and output vectors 850 to be essentially parallel.

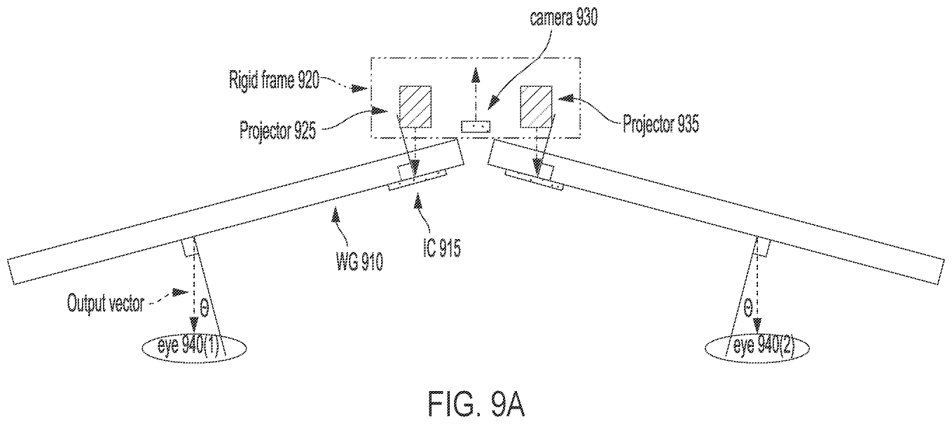

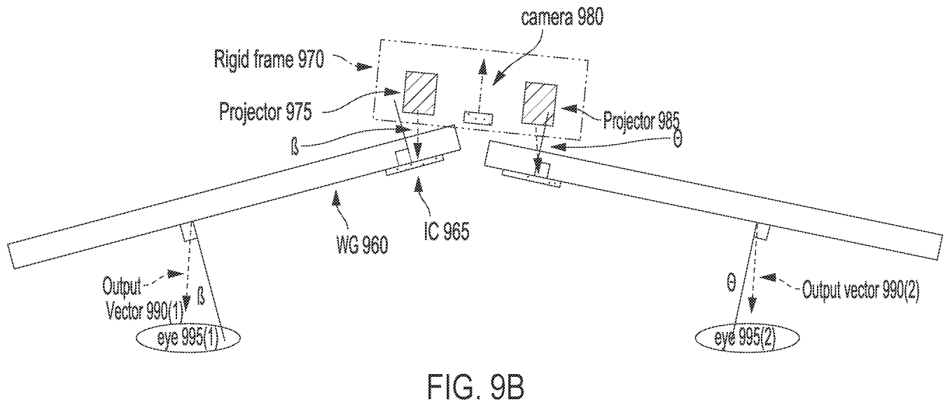

FIGS. 9A and 9B illustrate a nose bridge binocular display, in accordance with implementations described herein. As shown in FIG. 9A, the projection systems (left 925 and right 935) are included within a rigid frame 920 within the nose bridge, e g, the rigid frame 920 encloses the projection systems 925 and 935. The rigid frame 920 also includes and encloses the world-facing camera 930. The projection systems 925 and 935, in contrast, are directed toward the rim portions of the frame, in the opposite direction to the camera orientation. In this scenario, only the projection system and camera need to be rigidly coupled or aligned, while the remaining portions of the smartglasses may be flexible.

In FIG. 9B, the projection systems (left 975 and right 985) are included within a rigid frame 970 within the nose bridge. The rigid frame 970 also includes the world-facing camera 980. The projection systems 975 and 985, in contrast, are directed toward the rim portions of the frame, in the opposite direction to the camera orientation. In this scenario, only the projection system and camera need to be rigidly coupled or aligned, while the remaining portions of the smartglasses may be flexible. FIG. 9B shows the system in an arbitrary deflection with the camera and projection system aligned, the real and virtual objects remain aligned, and the output vectors 990(1) and 990(2) remain essentially parallel.

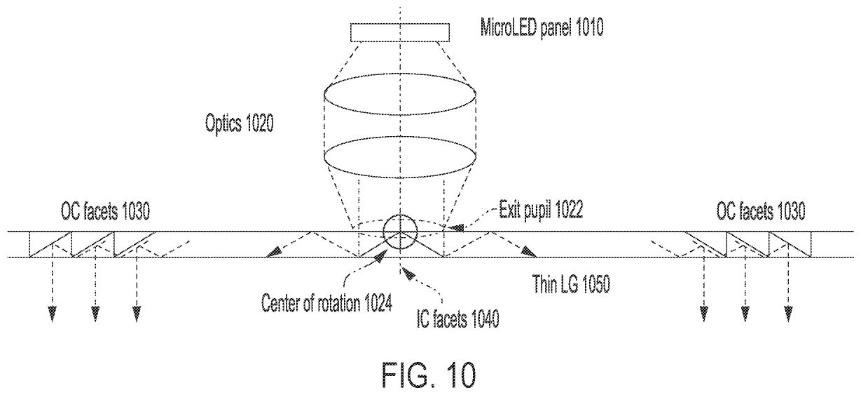

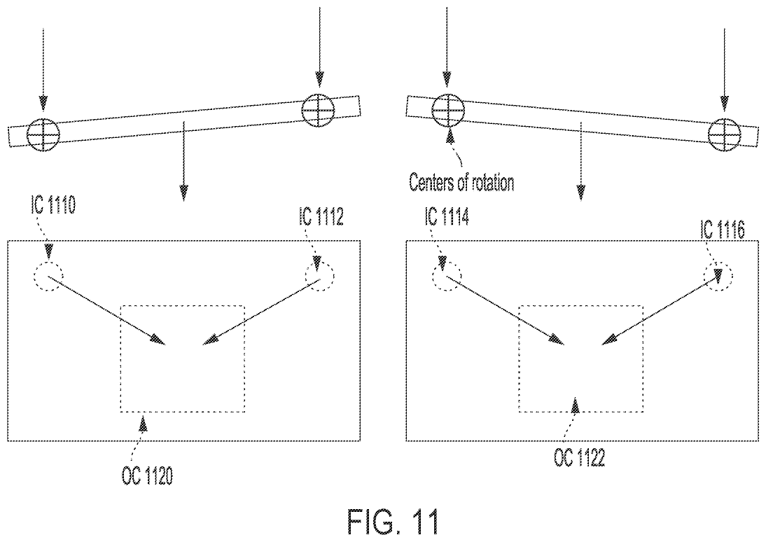

Some implementations allow for projector rotation relative to the waveguide (light guide). These are shown in FIGS. 10 and 11.

FIG. 10 is a diagram that illustrates a split pupil bi-ocular display with reflective incoupler facets. As shown in FIG. 10, a micro LED panel 1010 projects light through a set of optics 1020 toward an exit pupil 1022 of the optics 1020. Within the exit pupil 1022 are facets of an incoupler 1040 which couples light into a thin light guide (waveguide) 1050.

It is these facets 1040 which split the exit pupil 1022: some of the light from the micro LED panel 1010 goes one way into the light guide, and some of the light goes the other way (seen as left or right in FIG. 10). The light in the light guide 1050 is then outcoupled out of the light guide 1050 by outcoupler facets 1030 on either side of the incoupler facets 1040. It is noted that the light rays emerging from the outcouplers 1030 on either side of the light guide 1050 are essentially parallel to each other.

There is a center of rotation at the incoupler 1040 about which the light guide 1050 may rotate while keeping the output light rays from the outcouplers 1030 essentially parallel. This allows for the real and virtual images to remain aligned in the face of frame flexing.

FIG. 11 is a diagram illustrating a system with multiple incouplers per waveguide. As shown in FIG. 11, there are two incouplers 1110 and 1112 on a first (left) waveguide with outcoupler 1120, and there are two incouplers 1114 and 1116 on a second (right) waveguide with outcoupler 1122.

Each outcoupler 1120 and 1122 has a two-dimensional geometry. This two-dimensional geometry may be used for receiving light from the incoupler pairs 1110, 1112 and 1114, 1116. In some implementations, there may be more than two incouplers per outcoupler.

As with FIG. 10, each incoupler may be a center of rotation of the waveguide with respect to the light projector. When a waveguide rotates about one of these centers of rotation, the output from the outcoupler remains substantially parallel to (or in a fixed relation with) the input light and hence, the real and virtual images remain aligned. That is, the first incoupler and the second incoupler are disposed on the waveguide such that the output direction is substantially parallel to the initial direction of incidence independent of a rotation about either the first incoupler or the second incoupler.

In some implementations, an input light direction rerouter is configured to adjust the initial angle of incidence of the internally generated radiation at a surface of the waveguide to produce radiation directed at an adjusted angle of incidence at the second incoupler (e.g., 1112) such that the output direction is essentially parallel to the initial angle of incidence.

The example implementations described above illustrate various different hinge mechanisms, in accordance with implementations described herein, which may provide for rotatable coupling of a rim portion 103 and a temple arm portion 105 of a frame 102 of a head mounted wearable device 100. In the descriptions provided above, the rotatable coupling of one of the two temple arm portions 105 and the corresponding rim portion 103 is shown and described, simply for ease of discussion and illustration. The principles described above can be similarly applied to the rotatable coupling of the other of the two temple arm portions 105 to the corresponding rim portion 103 of the frame 102 of the head mounted wearable device 100.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A head-mounted wearable device, including:
a frame configured to be worn by a user, including:
a projection system configured to emit internally generated radiation;
a world-facing radiation detector configured to detect externally generated radiation, the world-facing radiation detector being rigidly coupled to the projection system;
a waveguide including:
an incoupler configured to couple the internally generated radiation into the waveguide to produce radiation in the waveguide; and
an outcoupler configured to couple the radiation in the waveguide out of the waveguide to produce outcoupled radiation, the outcoupled radiation being emitted from the outcoupler in an output direction toward an eye of the user; and
an input light direction rerouter configured to adjust an initial direction of incidence of the internally generated radiation at a surface of the waveguide to produce radiation directed at an adjusted angle of incidence at the incoupler such that the output direction is aligned to the initial direction of incidence.

2. The head-mounted wearable device as in claim 1, wherein a difference in direction between a chief ray of the world-facing radiation detector and a chief ray of the projection system is specified as a fixed value.

3. The head-mounted wearable device as in claim 2, wherein the chief ray of the world-facing radiation detector and the chief ray of the projection system are aligned.

4. The head-mounted wearable device as in claim 1, wherein the input light direction rerouter includes a retroreflector disposed on a side of the waveguide in which the projection system is disposed.

5. The head-mounted wearable device as in claim 1, wherein the input light direction rerouter includes a retroreflector disposed on a surface of the waveguide on a side opposite a side to which the projection system is disposed.

6. The head-mounted wearable device as in claim 5, wherein the surface of the waveguide on which the retroreflector is disposed is opposite a surface of the waveguide on which the incoupler is disposed.

7. The head-mounted wearable device as in claim 6, wherein the retroreflector includes a prism.

8. The head-mounted wearable device as in claim 5, wherein the internally generated radiation passes through the surface of the waveguide on which the incoupler is disposed prior to reflecting from the retroreflector.

9. The head-mounted wearable device as in claim 5, wherein the internally generated radiation passes through the incoupler prior to reflecting from the retroreflector.

10. The head-mounted wearable device as in claim 5, wherein the retroreflector forms a part of the surface of the waveguide opposite to surface of the waveguide on which the incoupler is disposed.

11. The head-mounted wearable device as in claim 1, wherein the incoupler of the waveguide is a first incoupler;
wherein the waveguide further includes a second incoupler configured to couple the internally generated radiation into the waveguide to produce the radiation in the waveguide; and
wherein the first incoupler and the second incoupler is disposed on the waveguide such that the output direction is substantially parallel to the initial direction of incidence independent of a rotation of the waveguide about either the first incoupler or the second incoupler.

12. The head-mounted wearable device as in claim 11, wherein the outcoupler has a two-dimensional geometry.

13. The head-mounted wearable device as in claim 1, wherein the incoupler is located at an exit pupil of a split pupil, bi-ocular optical system.

14. The head-mounted wearable device as in claim 13, wherein the incoupler includes facets configured to direct incident light to either of a first side of the waveguide or a second side of the waveguide.

15. A head-mounted wearable device, including:
a frame configured to be worn by a user, including:
a projection system configured to emit internally generated radiation;
a world-facing radiation detector configured to detect externally generated radiation, the world-facing radiation detector being rigidly coupled to the projection system such that a direction of a chief ray of the world-facing radiation detector is aligned to a direction of a chief ray of the projection system; and
a waveguide including:
an incoupler configured to couple the internally generated radiation into the waveguide to produce radiation in the waveguide; and
an outcoupler configured to couple the radiation in the waveguide out of the waveguide to produce outcoupled radiation, the outcoupled radiation being emitted from the outcoupler in an output direction toward an eye of the user.

16. The head-mounted wearable device as in claim 15, further including an input light direction rerouter configured to adjust an initial angle of incidence of the internally generated radiation at a surface of the waveguide to produce radiation directed at an adjusted angle of incidence at the incoupler such that the output direction is aligned to the initial direction of incidence.

17. The head-mounted wearable device as in claim 16, wherein the input light direction rerouter includes a retroreflector disposed on a side of the waveguide in which the projection system is disposed.

18. The head-mounted wearable device as in claim 15, wherein the incoupler of the waveguide is a first incoupler;
wherein the waveguide further includes a second incoupler configured to couple the internally generated radiation into the waveguide to produce the radiation in the waveguide; and
wherein the first incoupler and the second incoupler is disposed on the waveguide such that the output direction is substantially parallel to an initial angle of incidence independent of a rotation of the waveguide about either the first incoupler or the second incoupler.

19. The head-mounted wearable device as in claim 18, wherein the outcoupler has a two-dimensional geometry.

20. The head-mounted wearable device as in claim 15, wherein the incoupler is located at an exit pupil of a split pupil, bi-ocular optical system.

21. The head-mounted wearable device as in claim 20, wherein the incoupler includes facets configured to direct incident light to either of a first side of the waveguide or a second side of the waveguide.

22. A head-mounted wearable device, including:
a frame configured to be worn by a user, including:
a nose bridge, including:
a projection system configured to emit internally generated radiation;
a world-facing radiation detector configured to detect externally generated radiation, the world-facing radiation detector being rigidly coupled to the projection system; and
a rigid frame enclosing the projection system and the world-facing radiation detector; and
a waveguide including:
an incoupler configured to couple the internally generated radiation into the waveguide to produce radiation in the waveguide; and
an outcoupler configured to couple the radiation in the waveguide out of the waveguide to produce outcoupled radiation, the outcoupled radiation being emitted from the outcoupler in an output direction toward an eye of the user.

23. The head-mounted wearable device as in claim 22, wherein the incoupler of the waveguide is a first incoupler;
wherein the waveguide further includes a second incoupler configured to couple the internally generated radiation into the waveguide to produce the radiation in the waveguide; and
wherein the first incoupler and the second incoupler is disposed on the waveguide such that the output direction is substantially parallel to an initial angle of incidence independent of a rotation of the waveguide about either the first incoupler or the second incoupler.

24. The head-mounted wearable device as in claim 23, wherein the outcoupler has a two-dimensional geometry.

25. The head-mounted wearable device as in claim 22, wherein the incoupler is located at an exit pupil of a split pupil, bi-ocular optical system.

26. The head-mounted wearable device as in claim 25, wherein the incoupler includes facets configured to direct incident light to either of a first side of the waveguide or a second side of the waveguide.
